(19) United States
(12) Patent Application Publication
(10) Pub. No.: US 2012/0272167 A1
(43) Pub. Date: Oct. 25, 2012

(54) METHODS, APPARATUSES AND COMPUTER PROGRAM PRODUCTS FOR PROVIDING A MECHANISM FOR SAME ORIGIN WIDGET INTERWORKING

(75) Inventors: Cristiano di Flora, Lempaala (FI); Raine Valter Makelainen, Tampere (FI)

(73) Assignee: Nokia Corporation

(21) Appl. No.: 13/090,631

(22) Filed: Apr. 20, 2011

(51) Int. Cl. G06F 3/01

(52) U.S. Cl. 715/762

(57) ABSTRACT

An apparatus for determining whether widgets belong to the same origin based in part on an author signature may include a processor and memory storing executable computer program code that cause the apparatus to at least perform operations including evaluating data of a plurality of widgets that correspond, in part, to respective applications. The computer program code may cause the apparatus to determine whether the widgets belong to a same origin based in part on one or more author signatures of the data of the widgets. The computer program code may further cause the apparatus to determine whether to allow interaction between at least a portion of the widgets on the basis of the author signatures. Corresponding methods and computer program products are also provided.

### TECHNOLOGICAL FIELD

An example embodiment of the invention relates generally to provision of widgets on a terminal and, more particularly, relates to a method, apparatus, and computer program product for facilitating an efficient and reliable manner in which to determine whether widgets may interact and share resources, content or the like with each other.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal.

Additionally, user interface elements commonly referred to as “widgets” (e.g., HyperText Markup Language (HTML) pages) have been developed to provide applications and information to users in a more convenient manner. In this regard, a widget may be considered a downloadable, interactive virtual tool (e.g., software tool) or application that provides content. At present, web runtimes, built on top of a web engine, may provide an execution environment for widget components. In this regard, the web engine may be capable of rendering HTML and JavaScript™ contents. However, the widgets may typically be implemented by utilizing HTML and JavaScript™ run in an execution environment executed by a web runtime.

Additionally, widgets may be client-side applications that may be authored using Web standards, but whose content may be embedded into Web pages, Web documents or the like. In this regard, widgets may be digitally signed using a custom profile of an Extensible Markup Language (XML)-Signature Syntax that enables addition of an author signature as well as a distributor signature to a corresponding widget package.

The distributor signature is typically signed by the entity distributing the contents of the widget and the author signature is typically signed by the creator of the content of the widget. In this regard, a web runtime that may execute and facilitate the installation of a widget package may know the distributor signature and the author signature and may utilize this information to verify the integrity of the widget package. However, typically a web engine implementing a web browser may be unaware of the distributor signature and the author signature of a widget. As such, at present, web engines typically do not utilize the distribution signature or the author signature in determining whether widgets may interact and share resources or content with each other. Instead, at present, a web engine may allow some widgets to interact with other and share resources in instances in which the web engine determines that widgets belong to the same origin. In this regard, a web engine may utilize a same origin policy when determining whether to allow widgets to interact with each other. Currently, web engines typically determine that widgets belong to the same origin when the widgets are determined as belonging to the same domain. For example, if the web engine determines that widget A belongs to www.google.com and widget B belongs to www.mail.google.com, the web engine may determine that widget A and widget B are free to use each others resources since both widget A and widget B belong to the google.com domain.

On the other hand, the web engine may prohibit the sharing of resources between widgets in an instance in which the web engine determines that widget A and widget B belong to a different domain. For example, if the web engine determines that widget A belongs to www.google.com and that Widget B belongs to www.yahoo.com, the web engine may prohibit the sharing of resources and content between widget A and widget B since widget A belongs to the google.com domain and widget B belongs to a different domain such as yahoo.com.

Allowing widgets to interact with each other if they belong to the same domain while prohibiting widgets from interacting if the widgets belong to different domains may be somewhat restrictive. For instance, prohibiting widgets from interacting and sharing resources with each other when the widgets belong to different domains may minimize information exchange among widgets and may curtail sharing of additional functions and features that may be provided by widgets.

As such, it may be beneficial to provide a more flexible and configurable mechanism by which to control access to resources of widgets.

### BRIEF SUMMARY

A method, apparatus and computer program product are therefore provided for determining whether widgets belong to a same origin based in part on determining whether the widgets are created by the same author. In this regard, an example embodiment may determine that widgets belong to the same origin in response to determining that author signatures of the widgets correspond to the same author.

In an instance in which an example embodiment of the invention may determine that the author signatures of widgets correspond to the same author, an example embodiment may allow the corresponding widgets to interact with other. In this regard, the widgets may share resources, content or the like among each other. The author may be the creator or developer of the widgets.

On the other hand, in an instance in which an example embodiment may determine that the author signatures of widgets do not correspond to the same author, an example embodiment may restrict or prohibit the corresponding widgets from interacting with each other. In this regard, the widgets may not be able to share resources, content or the like with each other.

As such, an example embodiment of the invention may implement a same origin policy in which the origin of the widgets may be based on an author signature as opposed to a domain corresponding to the widgets or other location data corresponding to the widgets. In an instance in which at least two widgets may be signed by the same person as a developer or author or may be signed with the same author signature, an example embodiment may allow the at least two widgets to interact and share resources, content or the like with each other.

By utilizing an example embodiment of the invention, widgets of a common developer or author may bypass security restrictions imposed by an execution environment of the widgets in an instance in which the widgets of the developer/author may attempt to interact with one another. An example embodiment may also provide an easy, efficient an reliable manner in which to facilitate the creation of new functionalities for widgets of a developer/author by allowing the widgets to interact and share resources or content based on the same author originating or creating the widgets.

In one example embodiment, a method for determining whether widgets belong to the same origin based in part on an author signature is provided. The method may include evaluating data of a plurality of widgets that correspond, in part, to respective applications. The method may further include determining whether the widgets belong to a same origin based in part on one or more author signatures of the data of the widgets and determining whether to allow interaction between at least a portion of the widgets on the basis of the author signatures.

In another example embodiment, an apparatus for determining whether widgets belong to the same origin based in part on an author signature is provided. The apparatus may include a processor and a memory including computer program code. The memory and the computer program code are configured to, with the processor, cause the apparatus to at least perform operations including evaluating data of a plurality of widgets that correspond, in part, to respective applications. The memory and the computer program code may further cause the apparatus to determine whether the widgets belong to a same origin based in part on one or more author signatures of the data of the widgets and determine whether to allow interaction between at least a portion of the widgets on the basis of the author signatures.

In another example embodiment, a computer program product for determining whether widgets belong to the same origin based in part on an author signature is provided. The computer program product includes at least one computer-readable storage medium having computer executable program code instructions stored therein. The computer executable program code instructions may include program code instructions configured to evaluate data of a plurality of widgets that correspond, in part, to respective applications. The program code instructions may also be configured to determine whether the widgets belong to a same origin based in part on one or more author signatures of the data of the widgets and determine whether to allow interaction between at least a portion of the widgets on the basis of the author signatures.

An example embodiment of the invention may provide a better user experience since a mechanism of enabling interaction between widgets of a device may be enhanced. As a result, device users may enjoy improved capabilities and functionalities with respect to web widgets accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus for determining whether widgets belong to the same origin based in part on an author signature according to an example embodiment of the invention;

FIG. 3 is a schematic block diagram of another system according to an example embodiment of the invention;

FIG. 4 is a schematic block diagram of a network entity according to an example embodiment of the invention; and

FIG. 5 illustrates a flowchart for determining whether widgets belong to the same origin based in part on an author signature according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As used herein, the terms “widget(s),” “web widget(s),” “widget package(s)”, “web widget package(s)” and similar terms may be used interchangeably to refer to a client or terminal application(s) that may be authored using Web standards including, but no limited to, Hypertext Markup Language (HTML) (e.g., HTML5). The content of the widget(s) may be embedded in Web documents, Web pages or the like. The application(s) may be installed and executed within a Web page(s), Web document(s) or the like.

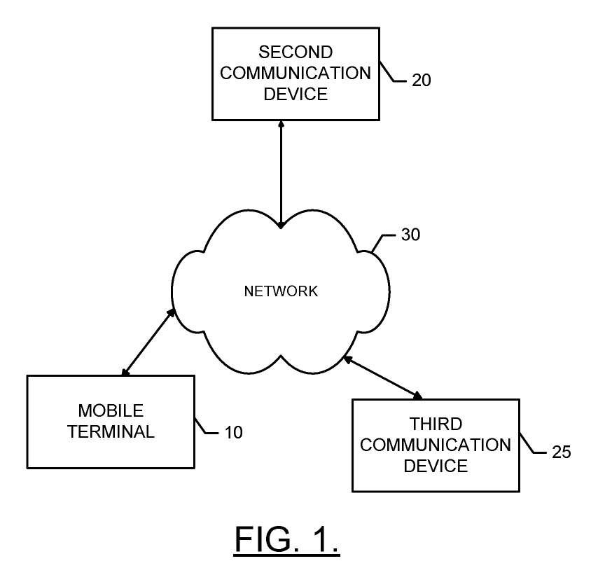

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

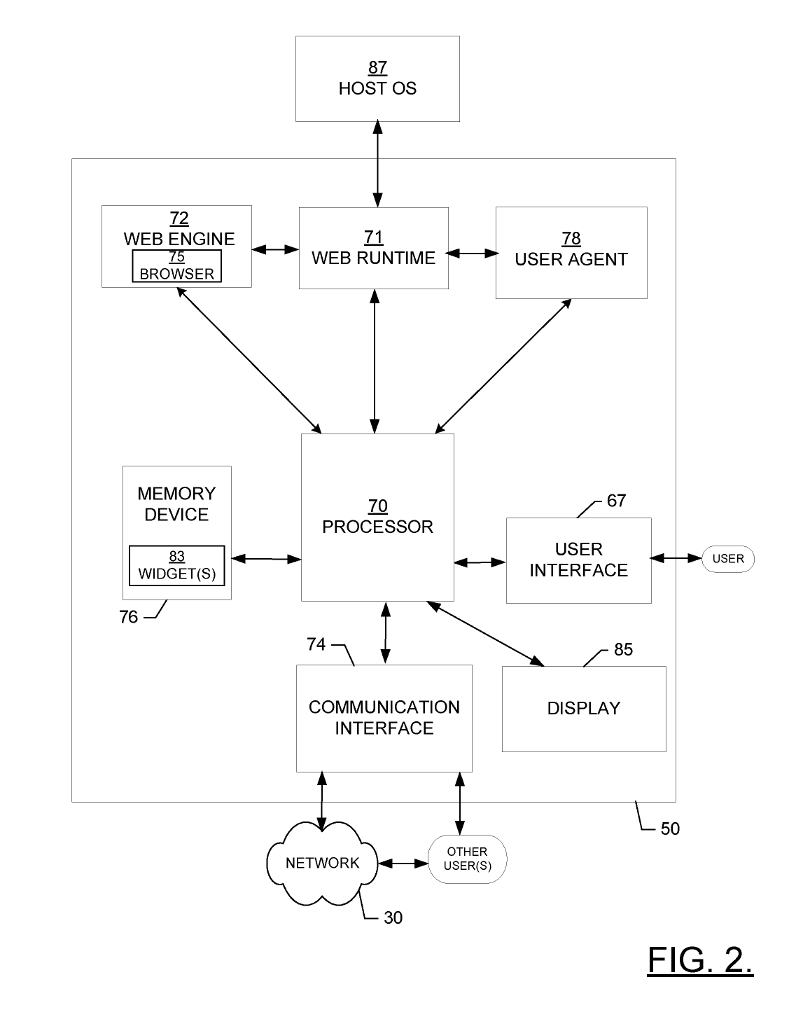

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a user agent (e.g., user agent 78 of FIG. 2). The user agent may evaluate data of widgets and determine whether the widgets belong to a same origin. The user agent may determine that the widgets belong to the same origin based in part on one or more author signatures of the widgets being signed by or corresponding to the same author.

In an example embodiment, the mobile terminal as well as the second and third communication devices 20 and 25 may be configured to include the user agent. However, in another alternative example embodiment, the mobile terminal 10 may include the user agent and the second and third communication devices 20 and 25 may be network entities such as, for example, servers or the like that are configured to communicate with the mobile terminal 10.

In an example embodiment, the mobile terminal as well as the second and third communication devices may employ an apparatus (e.g., apparatus of FIG. 2) capable of employing an embodiment of the invention.

FIG. 2 illustrates a schematic block diagram of an apparatus for determining whether widgets belong to the same origin based in part on an author signature. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, a web runtime 71, a host operating system (OS) 87 (also referred to herein as native host OS 87), a web engine 72 and a user agent 78. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). The memory device 76 may also store one or more widgets 83 (also referred to herein as widget package(s) 83). The widget(s) 83 may, but need not be, a widget(s) packaged according to the World Wide Web Consortium (W3C) Web Widget family of specifications. In an alternative example embodiment, the package format of the widget(s) 83 may conform to any other suitable package format. The widget(s) 83 may include one or more resources including but not limited to, one or more files such as, for example, widget Hypertext Markup Language (HTML) start files, JavaScript™ sources, images and any other suitable resources, data, content or the like.

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, and/or a coprocessor, such as, for example, web engine 72 that may execute a browser 75, Web browser (e.g., Firefox™, Internet Explorer™, Google Chrome™, Safari™, etc.) or the like. In this regard, the connectivity program may enable the apparatus 50 to transmit and receive Web content, such as for example location-based content, widgets or any other suitable content, according to a Wireless Application Protocol (WAP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The web runtime 71 may be any means such as a device or circuitry operating in accordance with software or otherwise embodied in hardware or a combination of hardware and software (e.g., processor 70 (and/or user agent 78) operating under software control, the processor 70 (and/or the user agent 78) embodied as an ASIC or FPGA specifically configured to perform the operations described herein, or a combination thereof) thereby configuring the device or structure to perform the corresponding functions of the web runtime 71, as described below.

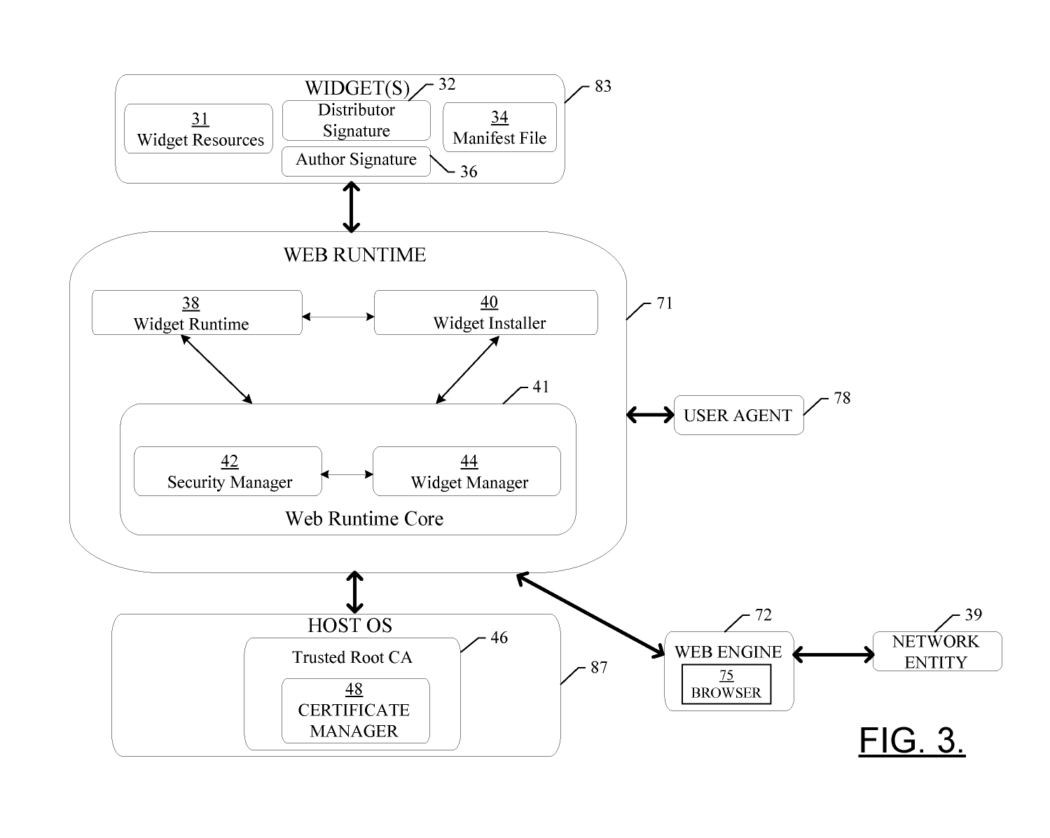

The web runtime 71 may provide the execution environment for the widget(s) 83. In this regard, the web runtime 71 may execute one or more widgets and may install one or more widgets (e.g., widget(s) 83) on the apparatus 50. The web runtime 71 may install one or more widgets on the apparatus 50 via a widget installer (See e.g., widget installer 40 of FIG. 3) on top of the native host OS 87. Moreover, it should be pointed out that the web runtime 71 may communicate with the native host OS 87 which may coordinate the activities associated with the interaction between widgets as well as sharing of resources and content among widgets.

The host OS 87 may include a certificate manager (See e.g., certificate manager 48 of FIG. 3) that may serve as a trust base for digital certificates in the host OS 87. The host OS 87 may be embodied in a computer program product as instructions that are stored in the memory of a communication device (e.g., the mobile terminal 10 and/or the second and third communication devices 20 and 25) and executed by the processor 70. Alternatively, the host OS 87 may be embodied as the processor 70 (e.g., as an FGPA, ASIC, or the like). Additionally, the host OS 87 may be any device or circuitry operating in accordance with software or otherwise embodied in hardware or a combination of hardware and software thereby configuring the device or circuitry to perform the corresponding functions of the host OS 87, as described herein. Although the host OS 87 is shown as being located external to the apparatus 50 in FIG. 2, it should be pointed out that the host OS 87 may be located internal to the apparatus 50 without departing from the spirit and scope of the invention.

In an example embodiment, the processor 70 may be embodied as, include or otherwise control the user agent 78. The user agent 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the user agent 78, as described below. Thus, in an example in which software is employed, a device or circuitry (e.g., the processor 70 in one example) executing the software forms the structure associated with such means.

The user agent 78 may implement or execute the functions of the web runtime 71. Additionally, the user agent 78 may analyze data of widgets (e.g., widget(s) 83) to determine whether the widgets are digitally signed with the same author signature. In an instance in which the user agent 78 determines that the widgets are signed with the same author signature, the user agent 78 may determine that the widgets belong to the same origin. In this regard, the user agent 78 may allow the widgets determined to have the same author signature to interact with each other and share content or resources, as described more fully below. On the other hand, in an instance in which the user agent 78 may determine that widgets are digitally signed with different author signatures, the user agent 78 may determine that the widgets do not belong to the same origin. As such, the user agent 78 may restrict or prohibit widgets digitally signed with different author signatures from interacting with each other and sharing resources, content or the like, as described more fully below.

Referring now to FIG. 3, an example embodiment of a system for facilitating interaction between widgets is provided. The system may include the host OS 87, the web runtime 71, one or more widget package(s) 83, the web engine 72, the user agent 78 and a network entity 39.

The web engine 72 may execute or implement the browser 75 configured to retrieve information, one or more applications, widgets, content, resources or the like from the World Wide Web (also referred to herein as Web) as well as information that is not necessarily or entirely related to the Web (e.g., information accessible via a private network, a file system(s), etc.). In this regard, for example, the web engine 72 may access one or more widgets. The web engine 72 may also facilitate interaction between widgets that are determined, by the user agent 78, to belong to the same origin. The same origin may be determined, by the user agent 78, based in part on an author signature of the widgets being the same, indicating that the same author is the creator of the widgets. The information, applications, content, resources, widgets, and any other suitable data may be accessible by the web engine 72 from a network entity 39 (e.g., a server). Although one network entity 39 is shown in FIG. 3, it should be pointed out that the web engine 72 may facilitate communications via any suitable number of network entities without departing from the spirit and scope of the invention.

In an example embodiment, the widget package(s) 83 may be received from the network entity 39. In an alternative example embodiment, the widget package(s) 83 may be pre-stored in the memory device 76. The widget package(s) 83 may include at least one manifest file 34. The manifest file 34 may describe widget metadata and may include one or more widget identifiers specified by the author of the widget package(s) 83. The author of the widget package(s) 83 may manage the widget package(s) 83 and may guarantee the uniqueness of the widget identifiers. Additionally, the widget package(s) 83 may include one or more widget resources 31. The widget resources 31 may include, but are not limited to, one or more files, such as, for example, widget HTML start files, JavaScript™ sources, images and any other suitable content, data or the like. The widget package(s) 83 may also include an author signature 36 digitally signed by the author (e.g., Author 1) or creator of the widgets. The widget package(s) 83 may also include a distributor signature 32 digitally signed by a distributor of the widget package(s) 83. In an example embodiment, the distributor may be an entity that distributes the contents of the widget package(s) 83 for usage.

The web runtime 71 may include a widget runtime 38, a widget installer 40 and a web runtime core 41. The web runtime core 41 may include a security manager 42 and a widget manager 44. Although certain functions may be described below as being performed by the web runtime 71, widget runtime 38, widget installer 40, security manager 42 and widget manager 44, it should be pointed out that in an example embodiment, the user agent 78 (e.g., as a processor, coprocessor, controller or the like) may implement these functions upon execution of the web runtime 71, widget runtime 38, widget installer 40, security manager 42 and widget manager 44.

The widget installer 40 may validate the integrity and validity of a given widget(s) and may install the widget(s) onto an apparatus (e.g., apparatus 50), as described more fully below. The installed widget(s) may be launched and executed by the widget runtime 38 upon being installed to the apparatus. In this regard, the widget runtime 38 may execute one or more widgets, installed via the widget installer 40, on top of the host OS 87.

The widget manager 44 may maintain a registry of all installed widgets and their corresponding widget identifiers (IDs). The security manager 42 may generate access control decisions in an instance in which one or more widgets may attempt to access resources of widgets outside of their corresponding widget package. In an example embodiment, the security manager 42 may determine that a widget may access resources of one or more other widgets in an instance in which the security manager 42 determines or verifies that the widgets belong to the same origin. The security manager 42 may determine that the widgets belong to the same origin in an instance in which the security manager 42 determines that the author of the widgets is the same. The security manager 42 may determine that the author is the same for the widgets based on verifying that the author signature corresponding to the widgets is the same.

The host OS 87 may include a certificate manager 48. The certificate manager 48 may serve as a trust base for one or more digital certificates in the host OS 87. In this regard, the certificate manager 78 may verify whether a digital certificate (e.g., a public key of a digital certificate) utilized to sign a widget(s) (e.g., a widget ID) of a widget package (e.g., widget package(s) 83) matches a digital certificate issued by the trusted root certificate authority (CA) 46 to a user (e.g., an author of the widget(s)), as described more fully below.

The trusted root CA 46 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the trusted root CA 46, as described below. In this regard, the trusted root CA 46 may be configured to issue one or more digital certificates. The digital certificates may certify the ownership of a public key by a named subject (e.g., an author of a widget(s)) of a certificate. In this regard, the trusted root CA 46 may issue one or more digital certificates that may include a public key and information identifying the owner, such as, for example, an author of a widget(s). The trusted root CA 46 may not make a corresponding matching private key available publicly. Instead, the private key may be kept secret by the owner (e.g., an author of a widget(s)) of the certificate). The digital certificates issued by the trusted root CA 46 may be X.509 certificates or any other suitable digital certificates.

In an example embodiment, in response to receipt of a selection by a user such as, for example, an author of a widget(s), the user agent 78 may sign a corresponding widget(s) created by the author with a digital certificate issued by the trusted root CA 46. For example, in response to receipt of a selection by a user, the user agent 78 may sign a corresponding widget(s), created by an author of the widget(s), with a public key of the digital certificate issued by the trusted root CA 46. In this regard, the user agent 78 may include data associated with the public key utilized to sign a corresponding widget(s) in an author-signature.xml file. The author-signature.xml file may be included in a widget package (e.g., widget package(s) 83).

During installation of a widget(s), by the widget installer 40 (e.g., in response to being executed by the user agent 78), created by an author, the widget installer 40 may verify the integrity and validity of the widget(s) being installed. In this regard, the widget installer 40 may analyze data in the author-signature.xml file to determine the whether the widget(s) (e.g., a widget ID) being installed is signed with a public key of the author that matches a public key of a digital certificate issued to the author by the trusted root CA 46. In this regard, in an instance in which the widget installer 40 determines that data in the author-signature.xml file indicates that the widget(s) being installed is signed with a public key of the author, the widget installer 40 may send a message to the certificate manager 46 requesting the certificate manager 48 to verify that the public key corresponds to a public key of a digital certificate issued by the trusted root CA 46.

In response to receipt of a message from the certificate manager 46 that the public key utilized to sign the widget(s) being installed matches a public key of a digital certificate issued to the author by the trusted root CA 46, the widget installer 40 may continue installation and may utilize a corresponding widget ID to identify the widget(s) thereafter.

On the other hand, in an instance in which the widget installer 40 may receive a message from the certificate manager 46 indicating that the public key of the author-signature.xml file does not match a public key of a digital certificate issued to the author by trusted root CA 46, the widget installer 40 may abort the installation of the widget(s) and may determine that the validation failed. In this regard, the widget installer 40 may determine that the public key, in the author-signature.xml file, that was utilized to sign the widget(s) previously being installed is invalid.

In an instance in which the widget installer 40 determines that the widgets are installed on an apparatus (e.g., apparatus 50) that are associated with the same author signature (e.g., author signature 36), the widget installer 40 may instruct the web runtime 71 that these widgets are allowed to utilize each other's content and resources. In this regard, the web runtime 71 may instruct the web engine 72 to allow the widgets to interact and share resources, content or the like with each other. As such, the web engine 72 may implement the browser 75 to allow widgets being signed with the same author signature to interact and share resources, content or the like with each other. Examples of the content or resources that may be shared among widgets having the same author signature or widgets which are signed by the same author include, but are not limited to, XML HTTP requests, script/image tag inclusion, embedding of contents via inner frames, widget HTML start files, JavaScript™ sources, images and any other suitable resources.

For purposes of illustration and not of limitation, consider an example in which an author such as, for example, author1 created widgetA and widgetB and another author such as, for example, author2 created another widget such as, for example, widgetC, as shown in the table set forth below.

| Widget | Widget ID |
|---|---|
| WidgetA | widget://author1domain.com/widgetA |
| WidgetB | widget://author1domain.com/widgetB |
| WidgetC | widget://author2domain.com/widgetC |

Authors may utilize a user interface (e.g., user interface 67) to include data in the manifest file of widgetA, widgetB and widgetC, specifying a widget ID for the corresponding widgets that may refer to the domain names they own or domain names that the widgets belong to. The widget ID of widgetA, widgetB and widgetC may be verified via a valid digital certificate, such as, for example, a X.509 digital certificate. The digital certificate may be issued by the trusted root CA 46.

In response to receipt of a selection, by the authors (e.g., author1 and author2) to sign the widgets (e.g., widgetA, widgetB, widgetC), the user agent 78 may determine whether each widget is signed by an author (e.g., author 1) with their corresponding digital certificate issued by the trusted root CA 46 which may be accessible by the certificate manager 48 of the host OS 87. As such, the author signatures (e.g., author signature 36) of each widget may be signed with the digital certificate (e.g., public key of the digital certificate) issued by the trusted root CA 46. In an instance in which the widget installer 40 may install widgets (e.g., widgetA, widgetB, widgetC), the widget installer 40 may parse an ID field of a manifest file (e.g., manifest file 34) and may extract a domain name corresponding to the widgets. The widget installer 40 may then validate the parsed ID (e.g., a widget ID) against the digital certificate of the author as indicated in a file such as, for example, an author-signature.xml file. The public key of the digital certificate may be used by user agent 78, for example, to validate the digital signature and to verify that the content, asserted to be signed by an author (e.g., author 1), is actually signed by the authorized author. The public key may be generated by the person who owns the “secret” private key associated with the public key. In an instance in which the user agent 78 determines that the parsed IDs matches or corresponds to a respective digital certificate issued by the trusted root CA 46 to respective authors (e.g., author1, author2), the widget installer 40 may proceed with the installation of the widgets and the corresponding widgets may be installed onto an apparatus (e.g., apparatus 50) by the widget installer 40. The user agent 78 may determine that the parsed IDs matches or corresponds to the respective digital certificates in response to receipt of an indication from the trusted root CA 46 verifying that the parsed IDs matches the corresponding issued digital certificates. In response to a valid/complete installation, the web runtime 71 may subsequently identify the widgets by using a corresponding widget ID specified in a manifest file (e.g., manifest file 34) of each of the widgets (e.g., widgetA, widgetB, widgetC).

On the other hand, in an instance in which the user agent 78 may determine that a parsed ID of a manifest file does not match a corresponding digital certificate issued to an author by the trusted root CA 46, the user agent 78 may abort the installation of a widget and may determine that the validation failed.

In an instance in which the security manager 42 (for example in response to being executed by the user agent 78) may determine that the widgets (e.g., widgetA, widgetB, widgetC) have the same origin, the security manager 42 may allow widgets to interact with each other and share resources, content or the like. In an example embodiment, the security manager 42 may determine that widgets have the same origin in an instance in which author signatures of the widgets are the same indicating that the widgets are created by the same author (e.g., author1).

For instance, in this example embodiment, the security manager 42 may analyze author signatures of the widgetA, widgetB and widgetC and may determine that widgetA and widgetB are signed by the same author, author1, in this example. In this regard, the web runtime 71 may instruct the web engine 72 to allow widgetA and widgetB to interact with each other and share resources, content or the like. As such, the browser 75 may enable interaction and sharing of resources, content or the like between widgetA and widgetB in response to receipt of a request to interact from widgetA or widgetB, for example. In this regard, the web engine 72 may instruct the browser 75 that widgetA and widgetB are signed by the same entity (e.g., author1) and as such widgetA and widgetB may be considered as having the same origin.

On the other hand, the security manager 42 may analyze the author signatures of widgetA and/or widgetB and the author signature of widgetC and may determine the author signature of widgetC is signed by a different author (e.g., author2) than the author (e.g., author1) signing widgetA and widgetB. As such, the security manager 42 may determine that the widgetC may not interact with or share resources, content or the like with widgetA or widgetB. In this regard, in an instance in which widgetB may attempt to embed widgetC or may attempt to access resources of widgetB by using an XML HTTP request (e.g., towards widget://author2domain.com/widgetC/index.html), for example, such request may be denied by the web runtime 71. In this manner, an example embodiment may allow interaction and sharing of resources among widgets based in part on the author signature of the widgets as opposed to relying on the domain or location data of widgets.

In an alternative example embodiment, an author(s) of widgets may utilize a user interface (e.g., user interface 67) to indicate their trust of other authors even in instances in which the author signatures of widgets may be different. In this regard, an author (e.g., author1) may utilize a user interface (e.g., user interface 67) to include data in a widget package (e.g., widget package(s) 83) indicating a list of one or more authors (e.g., author2) of one or more widgets (e.g., widgetC) that may be allowed to interact with and share resources, content or the like of a corresponding widget (e.g., widgetA, widgetB), even though the authors of the widgets may be different. In this regard, as an example, the security manager 42 may analyze data in a list of a widget package corresponding to widgetA (or widgetB) and may allow widgetA (or widgetB) to interact and share resources with widgetC in an instance in which the list of the widget package (e.g., widget package(s) 83) corresponding to widgetA (or widgetB) includes data specifying that author2 is a trusted author.

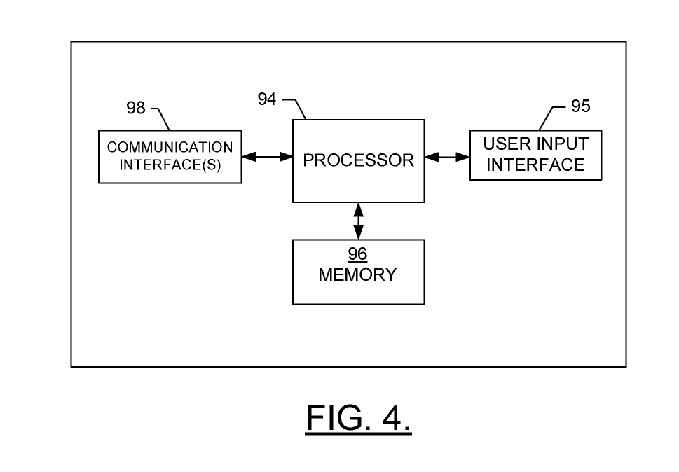

Referring now to FIG. 4, a block diagram of an example embodiment of a network entity, such as, for example, network entity 39 of FIG. 3 is provided. As shown in FIG. 4, the network entity (e.g., a server) generally includes a processor 94 and an associated memory 96. The memory 96 may comprise volatile and/or non-volatile memory, and may store content, data and/or the like. For example, the memory may store content, data, information, and/or the like transmitted from, and/or received by, the network entity. Also for example, the memory 96 may store client applications, instructions, and/or the like for the processor 94 to perform the various operations of the network entity in accordance with embodiments of the invention, as described above.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The network entity, for example network entity 39, may receive a request(s) from the browser 75 for content. The request(s) received from the browser 75 may include instructions to allow widgets (e.g., widgetA, widgetB) determined to be signed by the same author to interact and share resources, content or the like with each. The network entity may send corresponding resources or content that may be shared among the widgets to the web engine 72. In this regard, the web engine 72 may enable interaction between the widgets allowing the widgets to share the resources, content or the like received from the network entity.

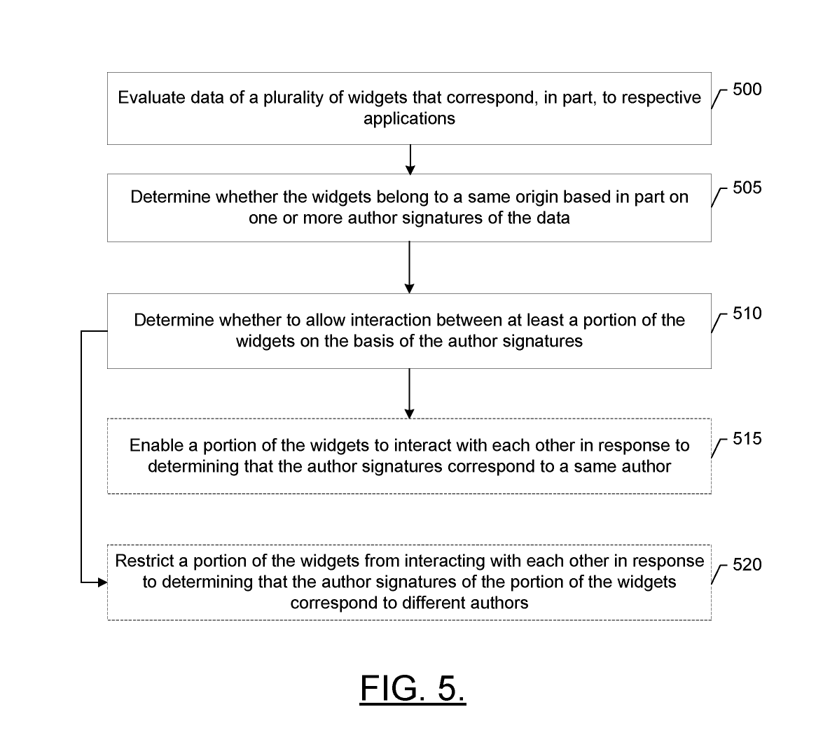

Referring now to FIG. 5, an example embodiment of a flowchart for determining whether widgets belong to the same origin based in part on an author signature is provided. At operation 500, an apparatus (e.g., apparatus 50) may evaluate data (e.g., a manifest file (e.g., manifest file 34)) of a plurality of widgets (e.g., widgetA, widgetB, widgetC) that correspond, in part, to respective applications. At operation 505, the apparatus (e.g., apparatus 50) may determine whether the widgets belong to a same origin based in part on one or more author signatures of the data. At operation 510, the apparatus may determine whether to allow interaction between at least a portion or a subset of the widgets on the basis of the author signatures.

Optionally, at operation 515, the apparatus may enable a portion of the widgets (e.g., WidgetA, WidgetB) to interact with each other in response to determining that the author signatures correspond to a same author (e.g., author 1). Optionally, at operation 520, the apparatus may restrict a portion of the widgets (e.g., WidgetA (or WidgetB) and WidgetC) from interacting with each other in response to determining that the author signatures of the portion of the widgets correspond to different authors (e.g., author 1 and author2).

It should be pointed out that FIG. 5 is a flowchart of a system, method and computer program product according to an example embodiment of the invention. It will be understood that each block of the flowchart, and combinations of blocks in the flowchart, may be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, user agent 78, web runtime 71, web engine 72, processor 94). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 5 above may comprise a processor (e.g., the processor 70, the user agent 78, the web runtime 71, the web engine 72, processor 94) configured to perform some or each of the operations (500-520) described above. The processor may, for example, be configured to perform the operations (500-520) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (500-520) may comprise, for example, the processor 70 (e.g., as means for performing any of the operations described above), the user agent 78, the web runtime 71, the web engine 72, the processor 94 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
evaluating data of a plurality of widgets that correspond, in part, to respective applications;
determining whether the widgets belong to a same origin based in part on one or more author signatures of the data of the widgets; and
determining, via a processor, whether to allow interaction between at least a portion of the widgets on the basis of the author signatures.

2. The method of claim 1, further comprising:
enabling the portion of the widgets to interact with each other in response to determining that the author signatures of the portion of the widgets correspond to a same author.

3. The method of claim 1, further comprising:
restricting the portion of the widgets from interacting with each other in response to determining that the author signatures of the portion of the widgets correspond to different authors.

4. The method of claim 1, further comprising:
enabling at least a first widget among the portion of the widgets to interact with at least a second widget among the portion of the widgets in response to determining that data of the first widget indicates that an author of the second widget is trusted, even though another author of the first widget and the author of the second widget are different.

5. The method of claim 2, wherein the interaction comprises sharing one or more resources or one or more items of content between the portion of the widgets.

6. The method of claim 1, wherein prior to determining whether to allow interaction, the method further comprises:
installing at least one of the widgets, among the portion of the widgets, onto an apparatus; and
determining, during the installing, whether information of a parsed widget identifier of the at least one widget corresponds to content of a certificate issued by a certificate authority, the certificate corresponds to an author.

7. The method of claim 6, further comprising:
completing the installing of the at least one widget in response to determining that the information of the parsed widget identifier corresponds to the content of the certificate.

8. The method of claim 7, wherein the information and the content relate, in part, to a public key assigned to a corresponding author of the at least one widget.

9. The method of claim 6, further comprising:
aborting the installing of the at least one widget, prior to completion, in response to determining that the information of the parsed widget identifier does not correspond to the content of the certificate; and
verifying that the at least one widget is invalid on the basis of the parsed widget identifier not corresponding to the content of the certificate.

10. An apparatus comprising:
at least one processor; and
at least one memory including computer program code, the at least one memory and the computer program code configured to, with the at least one processor, cause the apparatus to perform at least the following:
evaluate data of a plurality of widgets that correspond, in part, to respective applications;
determine whether the widgets belong to a same origin based in part on one or more author signatures of the data of the widgets; and
determine whether to allow interaction between at least a portion of the widgets on the basis of the author signatures.

11. The apparatus of claim 10, wherein the at least one memory and the computer program code are further configured to, with the processor, cause the apparatus to:
enable the portion of the widgets to interact with each other in response to determining that the author signatures of the portion of the widgets correspond to a same author.

12. The apparatus of claim 10, wherein the at least one memory and the computer program code are further configured to, with the processor, cause the apparatus to:
restrict the portion of the widgets from interacting with each other in response to determining that the author signatures of the portion of the widgets correspond to different authors.

13. The apparatus of claim 10, wherein the at least one memory and the computer program code are further configured to, with the processor, cause the apparatus to:
enable at least a first widget among the portion of the widgets to interact with at least a second widget among the portion of the widgets in response to determining that data of the first widget indicates that an author of the second widget is trusted, even though another author of the first widget and the author of the second widget are different.

14. The apparatus of claim 11, wherein the interaction comprises sharing one or more resources or one or more items of content between the portion of the widgets.

15. The apparatus of claim 10, wherein prior to determine whether to allow interaction, the at least one memory and the computer program code are further configured to, with the processor, cause the apparatus to:
install at least one of the widgets, among the portion of the widgets, onto an apparatus; and
determine, during the install, whether information of a parsed widget identifier of the at least one widget corresponds to content of a certificate issued by a certificate authority, the certificate corresponds to an author.

16. The apparatus of claim 15, wherein the at least one memory and the computer program code are further configured to, with the processor, cause the apparatus to:
complete the install of the at least one widget in response to determining that the information of the parsed widget identifier corresponds to the content of the certificate.

17. The apparatus of claim 16, wherein the information and the content relate, in part, to a public key assigned to a corresponding author of the at least one widget.

18. The apparatus of claim 15, wherein the at least one memory and the computer program code are further configured to, with the processor, cause the apparatus to:
abort the install of the at least one widget, prior to completion, in response to determining that the information of the parsed widget identifier does not correspond to the content of the certificate; and
verify that the at least one widget is invalid on the basis of the parsed widget identifier not corresponding to the content of the certificate.

19. A computer program product comprising at least one computer-readable storage medium having computer-executable program code instructions stored therein, the computer-executable program code instructions comprising:
program code instructions configured to evaluate data of a plurality of widgets that correspond, in part, to respective applications;
program code instructions configured to determine whether the widgets belong to a same origin based in part on one or more author signatures of the data of the widgets; and
program code instructions configured to determine whether to allow interaction between at least a portion of the widgets on the basis of the author signatures.

20. The computer program product of claim 19, further comprising:
program code instructions configured to enable the portion of the widgets to interact with each other in response to determining that the author signatures of the portion of the widgets correspond to a same author.
